(19) United States
(12) Patent Application Publication
(10) Pub. No.: US 2020/0041948 A1
(43) Pub. Date: Feb. 6, 2020

(54) FORMING APPARATUS

(71) Applicant: FUJI XEROX CO., LTD., Tokyo (JP)

(72) Inventors: Nobuhiro KATSUTA, Kanagawa (JP); Jiro MINABE, Kanagawa (JP); Daisuke NAKAYAMA, Kanagawa (JP)

(73) Assignee: FUJI XEROX CO., LTD., Tokyo (JP)

(21) Appl. No.: 16/262,942

(22) Filed: Jan. 31, 2019

(30) Foreign Application Priority Data
Aug. 6, 2018 (JP) 2018-147938

(51) Int. Cl. G03G 15/00; G06F 3/12

(52) U.S. Cl. CPC G03G 15/6552; G06F 3/1278

(57) ABSTRACT

A forming apparatus includes a discharge target device, a reducing device, and a discharge device. The reducing device reduces a section of a linear formation material in which a bundle of continuous fibers has been impregnated with resin. The discharge device moves relative to the discharge target device, discharges to the discharge target device the formation material the section of which has been reduced by the reducing device, and stacks plural layers formed of the formation material having been solidified.

### CROSS-REFERENCE TO RELATED APPLICATIONS

This application is based on and claims priority under 35 USC 119 from Japanese Patent Application No. 2018-147938 filed Aug. 6, 2018.

### BACKGROUND

### (i) Technical Field

The present disclosure relates to a forming apparatus.

### (ii) Related Art

Various embodiments relating to three-dimensional printers, reinforced filaments, and methods of using the three-dimensional printers and the reinforced filaments are described in Japanese Unexamined Patent Application Publication (Translation of PCT Application) No. 2016-531020.

### SUMMARY

There exists a related-art fused deposition modeling (FDM) forming apparatus (3D printer) that forms a formation product by discharging to a discharge target device a linear formation material in which a bundle of continuous fibers has been impregnated with resin and stacking a plurality of lengths of the formation material one on top of another.

In this forming apparatus, the bundle of continuous fibers is impregnated with resin, and then the formation material is discharged to the discharge target device while the sectional shape of the bundle of continuous fibers is maintained. In such a case, a force with which the continuous fibers are bonded to one another by the resin is small. Accordingly, the strength of the formation material included in the formation product may be insufficient.

Aspects of non-limiting embodiments of the present disclosure relate to an increase in the strength of a formation material included in a formation product compared to the case where a bundle of continuous fibers is impregnated with resin, and then the formation material is discharged to a discharge target device while the sectional shape of the bundle of continuous fibers is maintained.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a forming apparatus including a discharge target device, a reducing device, and a discharge device. The reducing device reduces a section of a linear formation material in which a bundle of continuous fibers has been impregnated with resin. The discharge device moves relative to the discharge target device, discharges to the discharge target device the formation material the section of which has been reduced by the reducing device, and stacks a plurality of layers formed of the formation material having been solidified.

### BRIEF DESCRIPTION OF THE DRAWINGS

Exemplary embodiment of the present disclosure will be described in detail based on the following figures, wherein:

FIG. 1 illustrates a configuration of a forming apparatus according to an exemplary embodiment of the present disclosure;

FIGS. 2A, 2B, and 2C are sectional views of a bundle of continuous fibers, a formation material, and the like used for the forming apparatus according to the exemplary embodiment of the present disclosure;

FIG. 3 is a perspective view of a heating transport device of the forming apparatus according to the exemplary embodiment of the present disclosure;

FIG. 4 is a block diagram of a control system of a controller included in the forming apparatus according to the exemplary embodiment of the present disclosure;

FIG. 5 is a graph illustrating a result of an evaluation performed by using the forming apparatus according to the exemplary embodiment of the present disclosure and a forming apparatus according to a comparative embodiment;

FIGS. 6A and 6B are sectional views respectively illustrating the formation material for the forming apparatus according to the exemplary embodiment of the present disclosure and the formation material for the forming apparatus according to the comparative embodiment;

FIG. 7 illustrates a configuration of the forming apparatus according to the comparative embodiment for the exemplary embodiment of the present disclosure;

FIG. 8 is a block diagram of a control system of a controller included in the forming apparatus according to the comparative embodiment for the exemplary embodiment of the present disclosure;

FIG. 9 is a sectional view of the formation material and the like used for the forming apparatus according to a variant of the exemplary embodiment of the present disclosure;

FIG. 10 is a sectional view of the formation material and the like used for the forming apparatus according to a variant of the exemplary embodiment of the present disclosure; and

FIG. 11 is a sectional view of the formation material and the like used for the forming apparatus according to a variant of the exemplary embodiment of the present disclosure.

### DETAILED DESCRIPTION

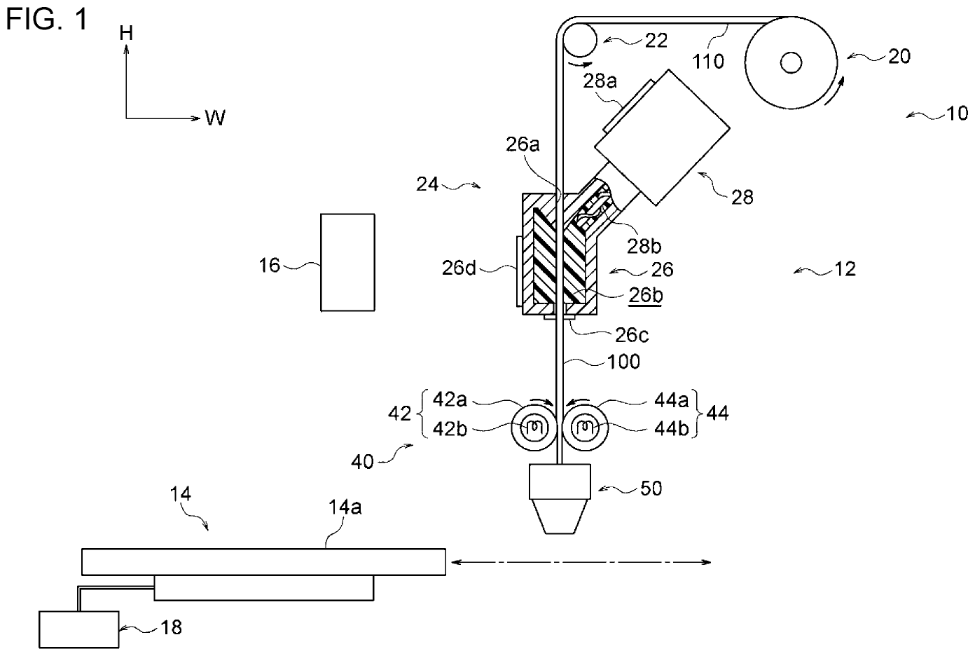

An example of a forming apparatus according to an exemplary embodiment of the present disclosure will be described with reference to FIGS. 1 to 11. In the drawings, an arrow H indicates an up-down direction of the apparatus (vertical direction), an arrow W indicates a width direction of the apparatus (horizontal direction), and an arrow D indicates a depth direction of the apparatus (horizontal direction).

### A Forming Apparatus 10

A forming apparatus 10 is a three-dimensional forming apparatus (3D printer) of a fused deposition modeling (FDM) type. The forming apparatus 10 forms a formation product by stacking plural layers one on top of another in accordance with layer data of the plural layers.

As illustrated in FIG. 1, the forming apparatus 10 includes a forming unit 12, a table device 14 disposed below the forming unit 12, a moving unit 18 that moves the table device 14, and a controller 16 that controls the components.

### The Forming Unit 12

As illustrated in FIG. 1, the forming unit 12 includes a reel 20, a routing roller 22, and an impregnating device 24. A bundle of continuous fibers (filaments), which is referred to as “fiber bundle 110” hereinafter, is wound on the reel 20. The impregnating device 24 impregnates the fiber bundle 110 with resin so as to obtain a linear formation material 100. The forming unit 12 further includes a heating transport device 40 and a discharge device 50. The heating transport device 40 transports the formation material 100 while applying pressure and heat to the formation material 100 so as to reduce the section of the formation material 100. The discharge device 50 discharges the formation material 100 to the table device 14. The heating transport device 40 is an example of a reducing device.

### The Reel 20, the Routing Roller 22

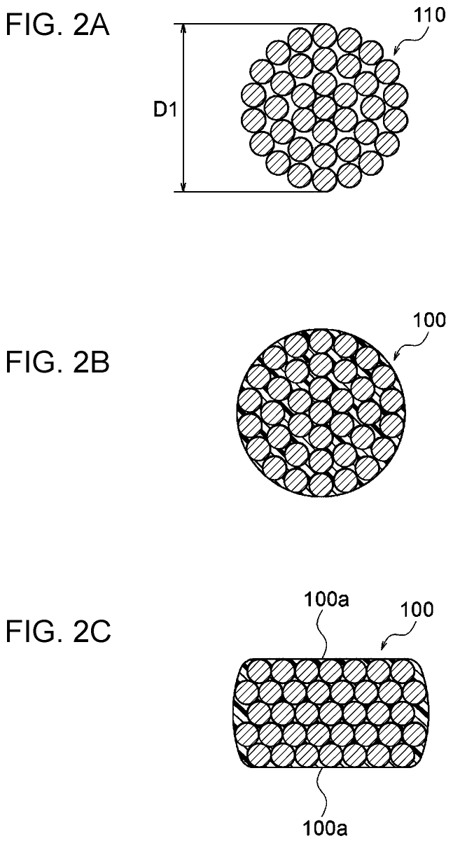

The reel 20 is supported such that the reel 20 is rotatable relative to an apparatus body (not illustrated). As described above, the fiber bundle 110 is wound on the reel 20. The fiber bundle 110 includes plural continuous fibers bundled together without being intertwined with one another. According to the present exemplary embodiment, the continuous fibers are exemplified by carbon fibers having a diameter of from 0.005 mm, and 1000 or more of the continuous fibers are bundled together. As illustrated in FIG. 2A, the section of the fiber bundle 110 in the bundled state has a circular shape having a diameter (Dl illustrated in FIG. 2A) of from 0.3 to 0.4 mm. It is noted that FIG. 2A illustrates the section in which the number of fibers is reduced.

As illustrated in FIG. 1, the routing roller 22 is disposed to one side of the reel 20 in the apparatus width direction (left side in FIG. 1) and supported such that the routing roller 22 is rotatable relative to the apparatus body. The fiber bundle 110 unwound from the reel 20 is looped over this routing roller 22.

In the above-described structure, the fiber bundle 110 extends in the apparatus width direction at a part upstream of the routing roller 22 in an unwinding direction of the fiber bundle 110 unwound from the reel 20 (“unwinding direction” hereinafter). The fiber bundle 110 extends in the apparatus up-down direction at a part downstream of the routing roller 22 in the unwinding direction.

### The Impregnating Device 24

As illustrated in FIG. 1, the impregnating device 24 is disposed downstream of the routing roller 22 in the unwinding direction. Furthermore, the impregnating device 24 includes a passage device 26 and a resin feed device 28. The passage device 26 allows the fiber bundle 110 to pass therethrough. The resin feed device 28 feeds resin to the passage device 26.

The resin feed device 28 contains the resin therein. The resin feed device 28 includes a heater 28a and a screw 28b. The heater 28a heats the resin contained in the resin feed device 28. The screw 28b feeds the heated resin to the passage device 26. According to the present exemplary embodiment, as an example, polypropylene resin serving as the resin is contained in the resin feed device 28, and the heater 28a heats the contained polypropylene resin to a temperature from 200 to 250° C. so as to melt the polypropylene resin.

The passage device 26 is disposed so as to allow the fiber bundle 110 unwound from the reel 20 to pass therethrough. The passage device 26 has a cylindrical shape extending in the up-down direction and has a receiving port 26a and a retaining portion 26b. The receiving port 26a receives the fiber bundle 110 unwound from the reel 20. The retaining portion 26b has a cylindrical shape and allows the resin to be retained therein such that the resin surrounds from the circumference the fiber bundle 110 passing therethrough. Furthermore, the passage device 26 includes a discharge head 26c and a heater 26d. The discharge head 26c allows the formation material 100 in which the fiber bundle 110 has been impregnated with the resin to be discharged therethrough. The heater 26d is mounted on the circumferential wall and heats the resin retained in the retaining portion 26b. The receiving port 26a, the retaining portion 26b, and the discharge head 26c are arranged in this order from an upper portion to a lower portion. According to the present exemplary embodiment, as an example, the heater 26d heats the polypropylene resin retained in the retaining portion 26b to a temperature from 200 to 250° C.

With the above-described structure, the resin feed device 28 feeds the heated resin to the retaining portion 26b of the passage device 26. The passage device 26 impregnates with the resin the fiber bundle 110 received through the receiving port 26a and passing through the retaining portion 26b. Furthermore, the passage device 26 discharges through the discharge head 26c the linear formation material 100 in which the fiber bundle 110 has been impregnated with the resin. In a state in which the formation material 100 has been discharged from the discharge head 26c, as illustrated in FIG. 2B, spaces between the fibers have been impregnated with the resin, and the section of the formation material 100 is a circular shape having a diameter of from 0.3 to 0.4 mm. It is noted that FIG. 2B illustrates the section in which the number of fibers is reduced.

The fibers are bonded to one another with the resin by impregnating the fiber bundle 110 with the resin as described above. Thus, the impregnating device 24 functions as a bonding device that causes the fibers to be bonded to one another.

Furthermore, the spaces between the fibers are filled with the resin by impregnating the fiber bundle 110 with the resin. This maintains the sectional shape of the fiber bundle 110. Thus, the impregnating device 24 functions as a section maintaining device that maintains the sectional shape of the fiber bundle 110.

### The Heating Transport Device 40

As illustrated in FIG. 1, the heating transport device 40 is disposed downstream of the impregnating device 24 in the unwinding direction. The heating transport device 40 includes, for example, a pair of heating rollers 42, 44 that apply heat and pressure to the formation material 100 and transports the formation material 100. The heating roller 44 is an example of a second heating roller. As another device, a heating portion and a belt including a pressure member therein may be used.

The heating roller 42 includes a cylindrical portion 42a and a heat source 42b. The cylindrical portion 42a is formed of metal and has a cylindrical shape the axial direction of which extends in the apparatus depth direction. The heat source 42b is disposed in the cylindrical portion 42a. A drive force is transmitted from a drive device (not illustrated) to the heating roller 42, thereby rotating the heating roller 42 in the circumferential direction.

The heating roller 44 is disposed on the opposite side of the formation material 100 to the heating roller 42. The heating roller 44 includes a cylindrical portion 44a and a heat source 44b. The cylindrical portion 44a is formed of metal and has a cylindrical shape the axial direction of which extends in the apparatus depth direction. The heat source 44b is disposed in the cylindrical portion 44a.

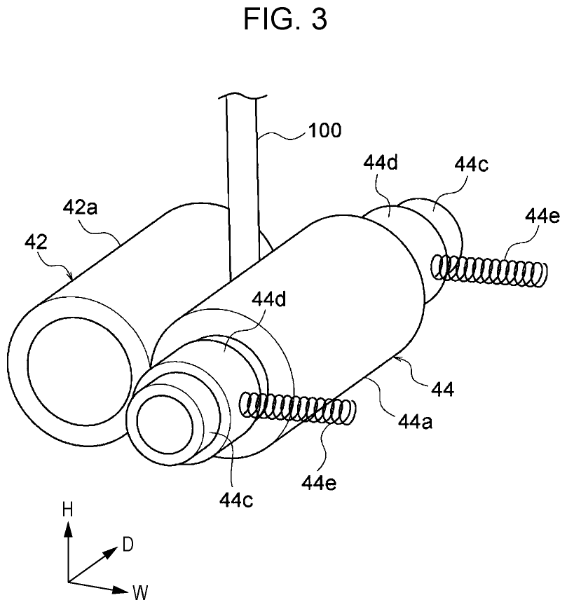

Furthermore, as illustrated in FIG. 3, the heating roller 44 includes a pair of shaft portions 44c and bearings 44d. The shaft portions 44c are formed at respective longitudinal ends of the cylindrical portion 44a. The shaft portions 44c having a cylindrical shape are parts of the shaft of the cylindrical portion 44a. The bearings 44d are attached to the respective shaft portions 44c. The heating roller 44 further includes a pair of urging members 44e that urge the cylindrical portion 44a toward the cylindrical portion 42a of the heating roller 42 through the bearings 44d. A drive force is transmitted from a drive device (not illustrated) to the heating roller 44, thereby rotating the heating roller 44 in the circumferential direction.

According to the present exemplary embodiment, as an example, the pair of the heating rollers 42, 44 heat the formation material 100 to a temperature from 200 to 250° C. Furthermore, the heating roller 44 applies to the formation material 100 pressure toward the heating roller 42 at 0.2 MPa. While rotating, the heating rollers 42, 44 pinch and transport the formation material 100 at a speed of 30 mm/sec. However, the speed at which the heating rollers 42, 44 transport the formation material 100 is not limited to the above-described speed.

With this structure, the pair of the rotating heating rollers 42, 44 unwind the fiber bundle 110 from the reel 20, and the impregnating device 24 impregnates with the resin the fiber bundle 110 unwound from the reel 20 so as to process the fiber bundle 110 into the formation material 100 as described above. Furthermore, the pair of the rotating heating rollers 42, 44 heat and pinch the formation material 100 having been supplied from the impregnating device 24 and solidified, and then heat the formation material 100. Then, the heating roller 44 applies to the formation material 100 pressure toward the heating roller 42.

Thus, the pair of the heating rollers 42, 44 change, as illustrated in FIGS. 2B and 2C, the formation material 100 having a circular sectional shape into a flat sectional shape, thereby reducing the section of the formation material 100. Here, the section having a flat shape is a section in which the length of the section in one direction is larger than the length in a direction intersecting the one direction in the section and a pair of surfaces facing in the intersecting direction (referred to as “flat surfaces 100a” hereafter) are formed. That is, the flat surfaces 100a are a pair of surfaces facing in the short side direction of the flat shape.

When the pair of the heating rollers 42, 44 apply heat and pressure to the formation material 100 as described above, the section of the formation material 100 is reduced. In other words, the fibers included in the formation material 100 are closely gathered together so as to increase the density of the formation material 100. Thus, the resin is compression bonded to the fibers, and accordingly, the strength with which the fibers are bonded to one another is increased. When the strength with which the fibers are bonded to one another is increased, the resistance of the formation material 100 against deformation is increased compared to that of the formation material 100 before the heat and pressure are applied. That is, compared to the formation material 100 before the heat and pressure are applied, the strength of the formation material 100 may be increased. According to the present exemplary embodiment, when the section of the formation material 100 before the heat and pressure are applied is 100%, the section of the formation material 100 is reduced to about 90%.

Furthermore, from the viewpoints of stability in shape and increasing the contact area between stacked lengths of the formation material 100, the rate of flattening of the formation material 100 is preferably 0.3 to 0.8 and particularly preferably 0.4 to 0.6.

As has been described, the pair of the heating rollers 42, 44 function as a transport device that transports the formation material 100 (fiber bundle 110) in the unwinding direction.

The pair of the heating rollers 42, 44 also function as a section reducing device that reduces the section of the formation material 100.

The pair of the heating rollers 42, 44 also function as a resistance increasing device that increases the resistance of the formation material 100 against deformation.

### The Discharge Device 50

As illustrated in FIG. 1, the discharge device 50 is disposed downstream of the impregnating device 24 in the unwinding direction. The discharge device 50 holds a portion of the formation material 100 at or near the distal end of the formation material 100 discharged toward the table device 14 and includes a heater (not illustrated) that heats the formation material 100 at the held portion.

### The Table Device 14, the Moving Unit 18

As illustrated in FIG. 1, the table device 14 is disposed below the forming unit 12 and has an upper surface 14a that is a horizontal surface facing upward, that is, facing the forming unit 12 side. The table device 14 is an example of a discharge target device and the upper surface 14a is an example of a discharge target surface.

The moving unit 18 moves the table device 14 in the apparatus width direction and the apparatus depth direction relative to the forming unit 12. The moving unit 18 also moves the table device 14 upward and downward relative to the forming unit 12.

### The Controller 16

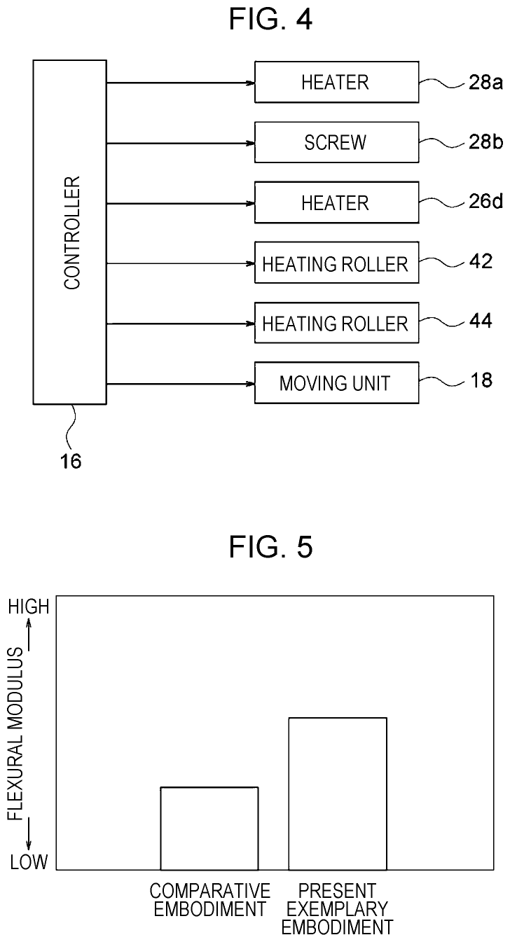

The controller 16 controls the heater 28a, the screw 28b, the heater 26d, the heating rollers 42, 44, and the moving unit 18 in accordance with plural pieces of the layer data generated from 3D data of the formation product (see FIG. 4). The configuration in which the controller 16 controls the components will be described together with features, which will be described later.

### Features of the Forming Apparatus 10

A method of forming the formation product by using the forming apparatus 10 is described while comparing the method with a method in which a forming apparatus 510 according to a comparative embodiment is used. First, the configuration of the forming apparatus 510 according to the comparative embodiment is described by focusing on the difference between the forming apparatus 510 and the forming apparatus 10.

### The Forming Apparatus 510

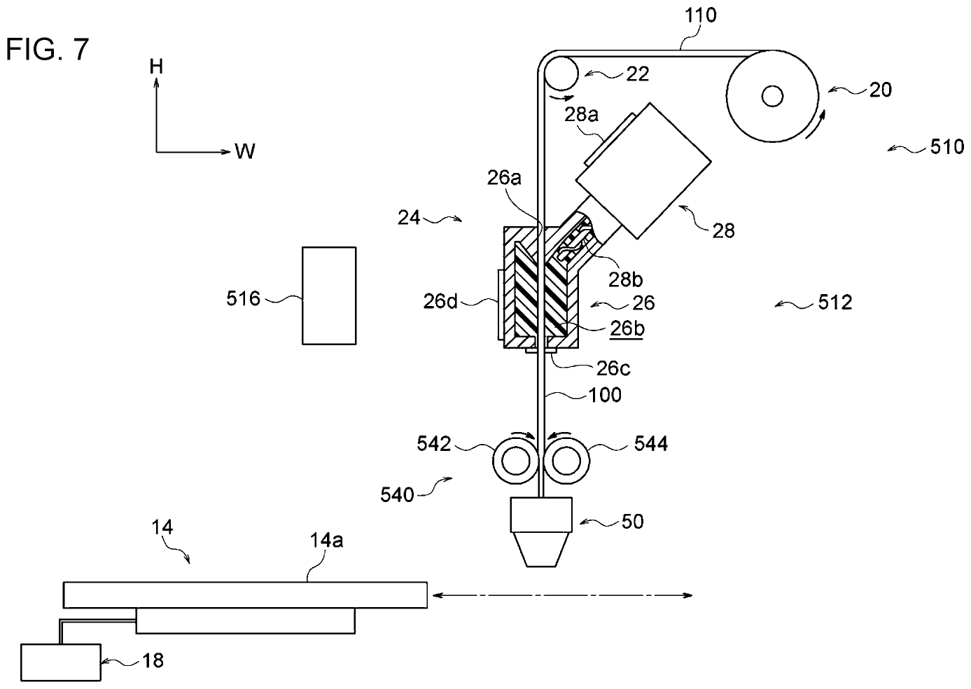

As illustrated in FIG. 7, the forming apparatus 510 includes a forming unit 512, the table device 14 disposed below the forming unit 512, the moving unit 18 that moves the table device 14, and a controller 516 that controls the components. The forming unit 512 further includes the reel 20, the routing roller 22, the impregnating device 24, a transport device 540, and the discharge device 50. The transport device 540 transports a formation material 100. The discharge device 50 discharges the formation material 100 to the table device 14.

The transport device 540 is disposed downstream of the impregnating device 24 in the unwinding direction. The transport device 540 includes a pair of transport rollers 542, 544. A drive force is transmitted from a drive device (not illustrated) to the transport rollers 542, 544, thereby rotating the transport rollers 542, 544 in the circumferential direction. Neither of the transport rollers 542, 544 includes a heat source.

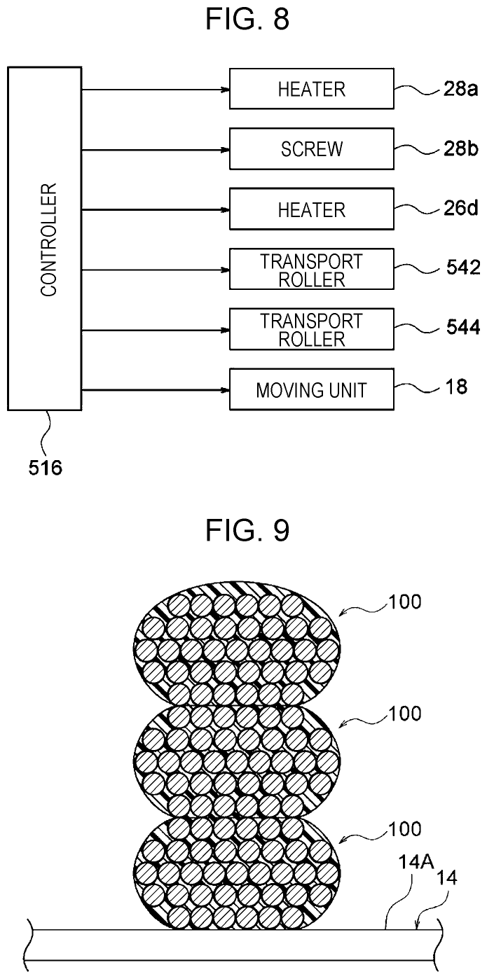

The controller 516 controls the heater 28a, the screw 28b, the heater 26d, the transport rollers 542, 544, and the moving unit 18 in accordance with plural pieces of layer data generated from 3D data of a formation product (see FIG. 8).

### The Method of Forming the Formation Product

In the method of forming the formation product by using the forming apparatus 10 or 510, the controller 16 or 516 controls the components. In accordance with the plural pieces of the layer data generated from the 3D data of the formation product, the moving unit 18 causes the table device 14 to reciprocate in the apparatus width direction while moving the table device 14 in the apparatus depth direction. The discharge device 50 discharges the linear formation material 100 onto the upper surface 14a without an interruption during discharge while heating the formation material 100. The discharged formation material 100 is solidified. When a single layer is formed by disposing the formation material 100 over the upper surface 14a, the moving unit 18 moves down the table device 14, and the above-described process is repeated so as to stack plural layers one on top of another. Thus, the formation product has been formed.

Specifically, when the forming apparatus 510 illustrated in FIG. 7 is used, the pair of the rotating transport rollers 542, 544 unwind the fiber bundle 110 from the reel 20 and transport the fiber bundle 110. Meanwhile, when the forming apparatus 10 illustrated in FIG. 1 is used, the pair of the rotating heating rollers 42, 44 unwind the fiber bundle 110 from the reel 20 and transport the fiber bundle 110.

In the resin feed device 28 of the forming apparatus 10 or 510, the resin heated by the heater 28a is fed to the retaining portion 26b of the passage device 26 by the rotating screw 28b. The passage device 26 impregnates with the resin the fiber bundle 110 received through the receiving port 26a and passing through the retaining portion 26b. Furthermore, the passage device 26 discharges through the discharge head 26c the linear formation material 100 in which the fiber bundle 110 has been impregnated with the resin.

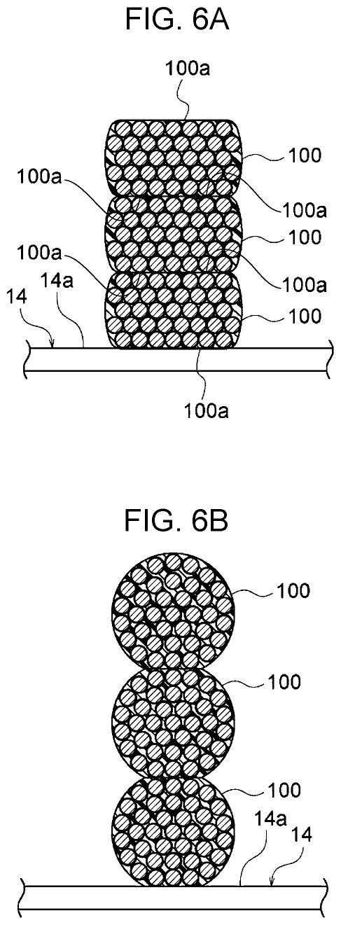

When the forming apparatus 510 illustrated in FIG. 7 is used, the pair of the rotating transport rollers 542, 544 pinch and transport the formation material 100 discharged from the passage device 26. In this way, the pair of the transport rollers 542, 544 transport the formation material 100 while the circular section (see FIG. 2B) is maintained. The discharge device 50 discharges the linear formation material 100 onto the upper surface 14a while heating the formation material 100. When a single layer is formed on the upper surface 14a, the moving unit 18 moves down the table device 14, and the above-described process is repeated so as to stack plural layers one on top of another. Thus, the formation product has been formed. Thus, when the forming apparatus 510 is used, as illustrated in FIG. 6B, lengths of the formation material 100 having a circular section are stacked on the upper surface 14a of the table device 14.

Meanwhile, when the forming apparatus 10 illustrated in FIG. 1 is used, the pair of the rotating heating rollers 42, 44 pinch and transport the formation material 100 discharged from the passage device 26 while heating the formation material 100. Furthermore, the heating roller 44 applies to the formation material 100 pressure toward the heating roller 42. Thus, the pair of the heating rollers 42, 44 change, as illustrated in FIGS. 2B and 2C, the sectional shape of the formation material 100 from a circular shape into a flat shape, thereby reducing the section of the formation material 100.

The size of the section is able to be determined by, for example, observing (photographing) the section with a scanning electron microscope (SEM), a digital microscope, or the like and measuring the dimensions on the observed image. Regarding the measurement, a sample before the transportation by the pair of the heating rollers 42, 44 and a sample after the transportation by the heating rollers 42, 44 are measured.

The discharge device 50 discharges the linear formation material 100 onto the upper surface 14a while heating the formation material 100. When a single layer is formed on the upper surface 14a, the moving unit 18 moves down the table device 14, and the above-described process is repeated so as to stack plural layers one on top of another. Thus, the formation product has been formed.

Here, the controller 16 causes the table device 14 to move such that one direction (longitudinal direction) of the section of the formation material 100 extends along the upper surface 14a. In other words, the controller 16 controls the moving unit 18 to move the table device 14 such that the flat surfaces 100a of the formation material 100 are brought into contact with or face the upper surface 14a. Thus, when the forming apparatus 10 is used, as illustrated in FIG. 6A, the lengths of the formation material 100 having a flat sectional shape are stacked on the upper surface 14a of the table device 14 such that the flat surfaces 100a are brought into contact with one another.

### Evaluation

Next, the flexural modulus of a test piece formed by using the forming apparatus 10 and a test piece formed by using the forming apparatus 510 is evaluated. The flexural modulus is evaluated (measured) by a method according to the Japanese Industrial Standards (JIS) K 7171 and the International Organization for Standardization (ISO) 0178 with a tension testing machine. FIG. 5 illustrates a graph of the result of the evaluation. The vertical axis of the graph represents the magnitude of the flexural modulus. As understood from the graph, the flexural modulus of the test piece (formation product) formed by using the forming apparatus 10 is higher than the flexural modulus of the test piece (formation product) formed by using the forming apparatus 510.

That is, the amount of deformation of the formation product due to an external force is smaller when the formation product is formed by using the forming apparatus 10 than when the formation product is formed by the forming apparatus 510. In other words, the resistance of the formation product against deformation is larger when the formation product is formed by using the forming apparatus 10 than when the formation product is formed by the forming apparatus 510. That is, the strength of the formation product formed by using the forming apparatus 10 may be increased compared to the strength of the formation product formed by using the forming apparatus 510.

### Summarization

As has been described, with the forming apparatus 10, the pair of the heating rollers 42, 44 reduce the section of the formation material 100, thereby increasing the strength with which the fibers are bonded to one another. Thus, the formation material 100 having the section reduced by pressure has increased resistance against deformation compared to that of the formation material 100 before the pressure is applied.

That is, compared to the case where the bundle of continuous fibers is impregnated with resin, and then the formation material 100 is discharged onto the table device 14 while the sectional shape of the bundle of continuous fibers is maintained, the strength of the formation material 100 included in the formation product may be increased.

Furthermore, with the forming apparatus 10, heat and pressure are applied to the linear formation material 100 in which the bundle of continuous fibers has been impregnated with the resin, thereby reducing the section of the formation material 100. Thus, for example, compared to the case where the section of the formation material is reduced only by applying pressure, the pressure to reduce the section is reduced.

Furthermore, with the forming apparatus 10, the pair of the heating rollers 42, 44 reduce the section of the formation material 100. Thus, for example, the section of the formation material 100 may have a simple and small-sized structure compared to the case where the heating process and the pressure applying process are separately performed.

Furthermore, with the forming apparatus 10, the pair of the heating rollers 42, 44 transport the formation material 100, thereby discharging the formation material 100 through the discharge device 50. Thus, for example, the number of components may be reduced compared to the case where a transport member that transports the formation material is provided separately from the heating rollers.

Furthermore, with the forming apparatus 10, the pair of the heating rollers 42, 44 increase the length of the section of the formation material 100 in one direction compared to the length of the section of the formation material 100 in the direction intersecting the one direction. Thus, for example, when the formation material 100 is discharged onto the upper surface 14a such that the one direction of the section of the formation material 100 extends along the upper surface 14a, the contact area between the stacked lengths of the formation material 100 is increased compared to the case where the section of the formation material is circular. Thus, compared to the case where the section of the formation material to be discharged onto the upper surface 14a is circular, the contact strength between the stacked lengths of the formation material 100 is increased. This may increase the strength of the formation product.

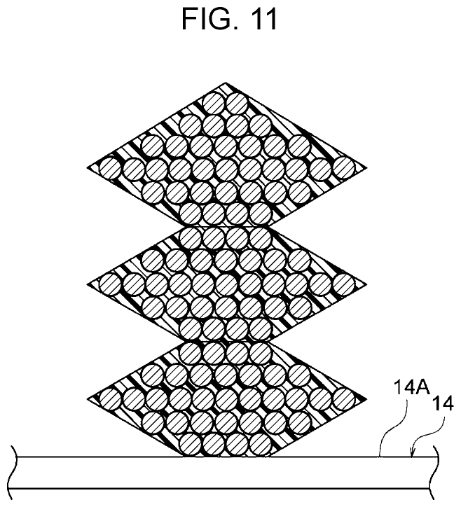

Furthermore, with the forming apparatus 10, the pair of the heating rollers 42, 44 change the shape of the section of the formation material 100 into a flat shape. Thus, for example, when the formation material 100 is discharged onto the upper surface 14a such that the flat surfaces 100a are brought into contact with or face the upper surface 14a, the contact area between the stacked lengths of the formation material 100 is increased compared to the case where the section of the formation material is a rhombus and the longitudinal direction of the section extends along the upper surface 14a (see FIG. 11). Thus, compared to the case where the section of the formation material discharged onto the upper surface 14a is a rhombus and the longitudinal direction of the section extends along the upper surface 14a, the contact strength between the stacked lengths of the formation material 100 is increased. This may increase the strength of the formation product.

Furthermore, with the forming apparatus 10, the controller 16 controls the moving unit 18 to move the table device 14 such that the one direction (longitudinal direction) of the section of the formation material 100 extends along the upper surface 14a. Thus, for example, the reduction of the strength of the formation product may be suppressed compared to the case where the intersecting direction (short side direction) of the section of the formation material 100 extends along the upper surface 14a.

Furthermore, with the forming apparatus 10, the controller 16 controls the moving unit 18 to move the table device 14 such that the flat surfaces 100a of the formation material 100 are brought into contact with or face the upper surface 14a. Thus, for example, the reduction of the strength of the formation product may be suppressed compared to the case where the intersecting direction (short side direction) of the section of the formation material 100 extends along the upper surface 14a.

Although the present disclosure has been described in detail with the specific exemplary embodiment, the present disclosure is not limited to this exemplary embodiment. It is obvious to one skilled in the art that various other exemplary embodiments are possible within the scope of the present disclosure. For example, according to the above-described exemplary embodiment, the pair of the heating rollers 42, 44 change, as illustrated in FIGS. 2B and 2C, the sectional shape of the formation material 100 from a circular shape into a flat shape. However, for example, compared to the case where the sectional shape of the formation material 100 is changed into a flat shape, the sectional shape of the formation material 100 may be changed from the circular shape into an elliptical shape as illustrated in FIG. 9 by performing at least one of reducing of the temperature of the heating rollers 42, 44 and reducing of the pressure applied by the heating roller 44. Alternatively, the sectional shape of the formation material 100 may be changed from a circular shape into an elliptical shape by changing the sectional shape of the heating rollers.

Here, the elliptical shape is a shape in which the length in one direction (long diameter) is larger than the length in the direction intersecting the one direction (short diameter) and the outer line is formed by convex curves. When the formation material has an elliptical shape as described above and the formation material 100 is discharged onto the upper surface 14a such that the one direction of the section of the formation material 100 extends along the upper surface 14a, the contact area between the stacked lengths of the formation material 100 is increased (see FIG. 9). Thus, compared to the case where the section of the formation material discharged onto the upper surface 14a is a rhombus and the longitudinal direction of the section extends along the upper surface 14a (see FIG. 11), the contact strength between the stacked lengths of the formation material 100 is increased. This may increase the strength of the formation product.

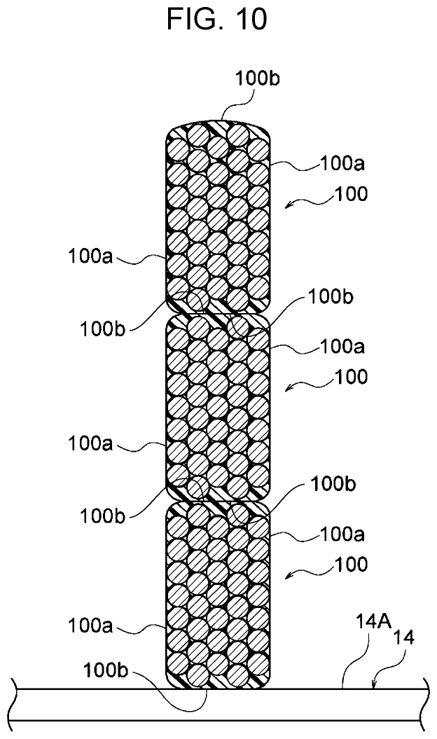

Furthermore, according to the above-described exemplary embodiment, the table device 14 is moved such that the flat surfaces 100a of the formation material 100 facing in the intersecting direction are brought into contact with or face the upper surface 14a. However, the table device 14 may be moved so that, as illustrated in FIG. 10, short surfaces 100b of the formation material 100 having a smaller length than that of the flat surfaces 100a are brought into contact with or face the upper surface 14a. In this case, although the contact strength between the stacked lengths of the formation material 100 is reduced compared to the case where the flat surfaces 100a are brought into contact with or face the upper surface 14a, the contact strength between the stacked length of the formation material 100 is increased compared to the case where the section of the formation material has a circular shape.

Furthermore, according to the above-described exemplary embodiment, the table device 14 is moved relative to the discharge device 50. However, the table device and the discharge device may be moved relative to each other by moving at least one of the discharge device and the table device.

According to the above-described exemplary embodiment, the formation material 100 is discharged onto the upper surface 14a of the table device 14. Alternatively, the formation material 100 may be discharged onto a cavity surface of a cavity so as to process the formation material.

According to the above-described exemplary embodiment, to reduce the section of the formation material 100, the heating roller 42 and the heating roller 44 that heats the formation material while applying pressure toward the heating roller 42 to the formation material are used to perform the heating process and the pressure applying process in a single step. Alternatively, the heating process and the pressure applying process may be performed in separate steps. In this case, however, features that would be obtained by using the pair of the heating rollers 42, 44 to reduce the section of the formation material 100 are not obtained.

Furthermore, according to the above-described exemplary embodiment, the heating transport device 40 reduces the circular section of the formation material such that the length of the section of the formation material 100 in the one direction is larger than the length of the section of the formation material 100 in the direction intersecting the one direction. However, the heating transport device may reduce the section of the formation material while the circular sectional shape is maintained. In this case, features that would be obtained by increasing the length of the section of the formation material in the one direction compared to the length in the intersecting direction are not obtained.

Although the forming apparatus 10 includes the impregnating device 24 according to the above-described exemplary embodiment, the forming apparatus 10 does not necessarily include the impregnating device 24. It is sufficient that the formation material in which a bundle of continuous fibers is impregnated with the resin be transported by the pair of the heating rollers 42, 44.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A forming apparatus comprising:
a discharge target device;
a reducing device that reduces a section of a linear formation material in which a bundle of continuous fibers has been impregnated with resin; and
a discharge device that moves relative to the discharge target device, that discharges to the discharge target device the formation material the section of which has been reduced by the reducing device, and that stacks a plurality of layers formed of the formation material having been solidified.

2. The forming apparatus according to claim 1, further comprising:
an impregnating device that impregnates the bundle of continuous fibers with the resin so as to supply the linear formation material to the reducing device.

3. The forming apparatus according to claim 1,
wherein the reducing device reduces the section of the formation material by applying pressure and heat to the formation material.

4. The forming apparatus according to claim 3,
wherein the reducing device includes
a first heating roller that includes a heat source disposed therein, and
a second heating roller that includes a heat source disposed therein and that applies to the formation material the pressure toward the first heating roller.

5. The forming apparatus according to claim 4,
wherein the first heating roller that is rotating and the second heating roller that is rotating pinch and transport the formation material so as to discharge the formation material through the discharge device.

6. The forming apparatus according to claim 1,
wherein the reducing device reduces the section of the formation material having a circular sectional shape such that a length of the section of the formation material in one direction is larger than a length of the section of the formation material in a direction intersecting the one direction.

7. The forming apparatus according to claim 6,
wherein the reducing device reduces the section of the formation material such that the section of the formation material is a flat shape.

8. The forming apparatus according to claim 6,
wherein the reducing device reduces the section of the formation material such that the section of the formation material is an elliptical shape.

9. The forming apparatus according to claim 6,
wherein the discharge target device includes a discharge target surface on which the formation material discharged through the discharge device is to be placed, and
wherein at least one of the discharge target device and the discharge device moves relative to another such that the one direction of the section of the formation material extends along the discharge target surface in a state in which the formation material is placed on the discharge target surface.

10. The forming apparatus according to claim 8,
wherein the discharge target device includes a discharge target surface on which the formation material discharged through the discharge device is to be placed, and
wherein at least one of the discharge target device and the discharge device moves relative to another such that a flat surface of the formation material is brought into contact with or faces the discharge target surface in a state in which the formation material is placed on the discharge target surface.
